(19) United States
(12) Patent Application Publication
(10) Pub. No.: US 2016/0011891 A1
(43) Pub. Date: Jan. 14, 2016

(54) Engine for Virtual Machine Resources

(71) Applicant: Dell Products L.P., Round Rock, TX (US)

(72) Inventors: Slawomir Dorzak, Dublin (IE); Vlad Munthiu, Dublin (IE)

(73) Assignee: DELL PRODUCTS L.P., Round Rock, TX (US)

(21) Appl. No.: 14/327,006

(22) Filed: Jul. 9, 2014

(51) Int. Cl. G06F 9/455

(52) U.S. Cl. CPC G06F 9/45533

(57) ABSTRACT

A system, method, and computer-readable medium are disclosed for automating the identification and classification of virtual machines (VMs) into VM generation classifications. VM utilization data associated with a target VM is processed to identify a corresponding VM generation classification (GC) value, which is then associated with the target VM.

### BACKGROUND OF THE INVENTION

1. Field of the Invention

The present invention relates to the management of information handling systems. More specifically, embodiments of the invention provide a system, method, and computer-readable medium for automating the classification of virtual machines (VMs) into VM generation classifications.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Today's enterprise face many challenges, including reducing the total cost of ownership (TCO) of their information processing operations. One approach that has gained popularity in recent years is virtualization, which allows a single resource, such as a server, an operating system, an application, or storage device appear to function as multiple logical resources. Conversely, virtualization can also make multiple physical resources, such as storage devices or servers, appear as a single logical resource.

A primary enabler of virtualization is a virtual machine (VM), which is software that creates a virtualized environment between an underlying computer platform and a guest operating system, such that the end user can operate software on an abstract machine. Another key enabler of virtualization is a virtual machine monitor (VMM), also commonly known as a hypervisor, which is typically implemented to manage multiple VM instances on a host computer at the same time. However, managing the execution of multiple VMs across multiple VM hosts, and the resources they include, becomes challenging as the size of the virtual execution environment grows. In particular, identifying and classifying unused or underutilized VMs can prove to be challenging.

### SUMMARY OF THE INVENTION

A system, method, and computer-readable medium are disclosed for automating the classification of virtual machines (VMs) into VM generation classifications. In various embodiments, VM resource utilization data associated with a target VM is process to generate a set of VM utilization data. In turn, the set of VM utilization data is processed to identify an associated set of VM utilization data, which has a corresponding VM generation classification (GC) value that is then associated with the target VM.

In various embodiments, the VM generation value may have a value of ‘−1.’ ‘0’, ‘1’ or ‘2.’ In these embodiments, a VM generation value of ‘−1’ indicates that the target VM is either not currently in use, is underutilized, is marked for suspension, termination or deletion, or some combination thereof. Likewise, a VM generation value of ‘0’ indicates that the target VM is either newly initiated, has been in operation for at least a predetermined minimum period of time, exceeds a predetermined minimum level of VM utilization, has an associated high mortality rate, or some combination thereof.

Likewise, a VM generation value of ‘1’ indicates that the target VM has been in operation for a period of time that is greater than a predetermined minimum period of time and less than a predetermined maximum period of time, has a level of VM utilization that is greater than a predetermined minimum level of VM utilization and less than a predetermined maximum level of VM utilization, or both. Likewise, a VM generation value of ‘2’ indicates the target VM has been in operation exceeding a predetermined minimum period of time, exceeds a predetermined minimum level of VM utilization, is designated a permanent or prioritized VM, or some combination thereof.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of a virtual machine (VM) classification system used to automate the classification of VMs into VM generation classifications;

FIGS. 3A-3D are a simplified block diagram showing the automated classification of VMs into VM generation classifications; and

FIGS. 4A-4C are a generalized flowchart of the performance of operations to automate the classification of VMs into VM generation classifications.

### DETAILED DESCRIPTION

A system, method, and computer-readable medium are disclosed for automating the identification and classification of virtual machines (VMs) into VM generation classifications. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

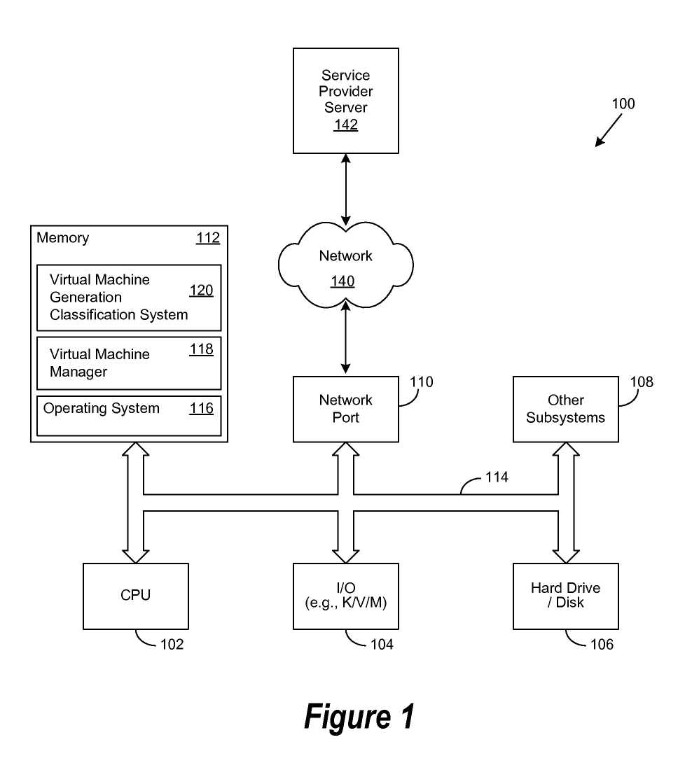

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a virtual machine manager (VMM) 118, also known as a Hypervisor, and a virtual machine generation classification system 120. In one embodiment, the information handling system 100 is able to download the virtual machine generation classification system 120 from the service provider server 142. In another embodiment, the virtual machine generation classification system 120 is provided as a service from the service provider server 142.

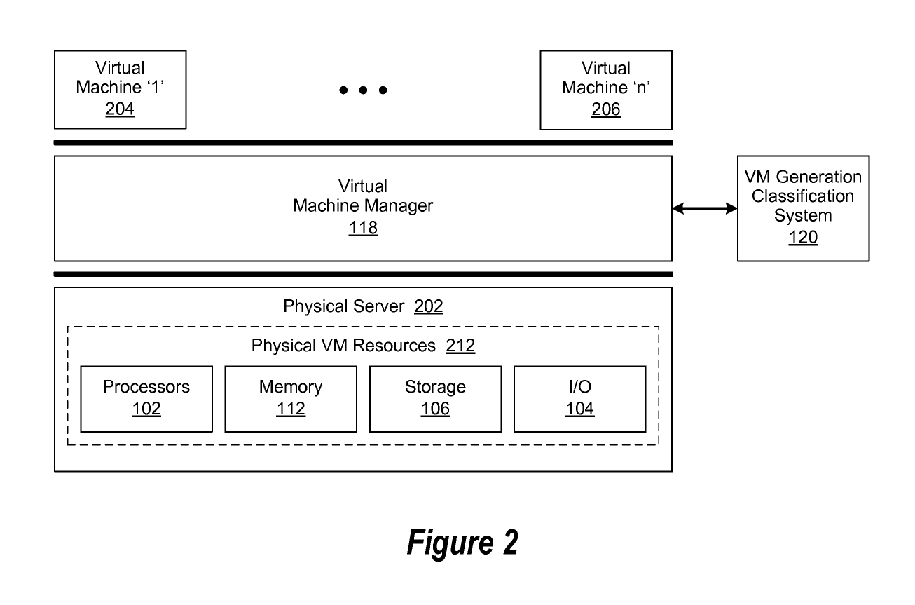

FIG. 2 is a simplified block diagram of a virtual machine (VM) generation classification (GC) system implemented in accordance with an embodiment of the invention to automate the classification of VMs into VM generation classifications. As used herein, a VM generation, when used in the context of the generation classification of VMs, broadly refers to a class of VM utilization. As an example, the utilization of a VM may relate to the length of time that the VM has been in operation, the utilization of its assigned physical resources (e.g., CPU, memory, I/O, storage, etc.), the application(s) it is assigned to run, or any combination thereof. Skilled practitioners of the art will recognize that many such examples of VM utilization are possible and the foregoing is not intended to limit the spirit, scope or intent of the invention.

In this embodiment, a virtual machine manager (VMM) 118, also known to those of skill in the art as a virtual machine monitor or a hypervisor, is implemented on physical server 202 for the execution and management of VM ‘1’ 204 through ‘n’ 206. In this and other embodiments, the physical server 202 may include physical VM resources 212, which in different embodiments may include one or more processors 102, memory 112, mass storage 106, such as disk and tape drives, and input/output (I/O) 104. In various embodiments, the implementation of a VMM 118 allows the physical VM resources 212 to be abstracted, or virtualized. This resource virtualization results in the VM resources 212 appearing as logical resources that can be dynamically assigned to VM ‘1’ 204 through ‘n’ 206 by the VMM 118.

In various embodiments, a VM GC system 120 is implemented with the VMM 118 to automate the generation classification of individual VMs of VMs ‘1’ 204 through ‘n’ 206 into VM generation classifications according to their respective utilization. In these embodiments, various VM utilization parameters, described in greater detail herein, are configured and then associated with a corresponding VM GC value. In certain embodiments, each of these configurable parameters may include a minimum bound, a maximum bound, or both.

During the performance of VM GC operations, the current utilization of individual VMs of VMs ‘1’ 204 through ‘n’ 206 is compared to the bounds of the various VM utilization parameters corresponding to their current VM GC value. In various embodiments, a VM's GC value is revised according to its current utilization. In these embodiments, the VM GC value may include:

A first VM GC value, which in certain embodiments includes a numeric value of ‘−1’, indicating that an associated VM is either not being used, or is underutilized, and has been marked for suspension, termination or deletion.

A second VM GC value, which in certain embodiments includes a numeric value of ‘0’, indicating that an associated VM may be newly initiated, has been in operation for at least a predetermined minimum period of time, exceeds a predetermined minimum level of VM resource utilization (e.g., >20%), or has an associated high mortality rate.

A third VM GC value, which in certain embodiments includes a numeric value of ‘1’, indicating that an associated VM has been in operation for a period of time that is greater than a predetermined minimum period of time and less than a predetermined maximum period of time, has a level of VM resource utilization that is greater than (e.g., >50%) a predetermined minimum level of VM resource utilization, and less than (e.g., <80%) a predetermined maximum level of VM resource utilization.

A fourth VM GC value, which in certain embodiments includes a numeric value of ‘2’, indicating that an associated VM has been in operation exceeding a predetermined minimum period of time, exceeds a predetermined minimum level of VM resource utilization (e.g., >80%), or is designated as a permanent or prioritized VM.

In one embodiment, the VM GC operations are performed when overall utilization of physical VM resources 212 is in a stressed or fully-used state. In another embodiment, the VM GC operations are manually initiated by a user. In yet another embodiment, the VM GC operations are automatically initiated by an automated process. The method by which the VM GC operations are invoked is a matter of design choice. In still another embodiment, the VM GC operations are implemented with a resource management system to automatically release or migrate physical VM resources 212 according to their associated VM GC value. It will be appreciated that many such embodiments are possible and the foregoing is not intended to limit the spirit, scope or intent of the invention.

In various embodiments, VM GC operations are initiated by first identifying a set of target VMs ‘1’ 204 through ‘n’ 206 for VM generation classification. The method of identifying the set of target VMs for the performance of VM GC operations is a matter of design choice. Once the predetermined set of target VMs ‘1’ 204 through ‘n’ 206 has been identified, predetermined VM utilization parameters, as described in greater detail herein, are configured for their associated VM GC values.

A target VM of VMs ‘1’ 204 through ‘n’ 206 is then selected, followed by a determination being made whether it currently has an associated VM GC value. If not, then its associated VM GC value is set to ‘0.’ However, if it is determined that the target VM currently has an associated VM GC value, then a determination is made whether its utilization meets the VM utilization parameters associated with a VM GC value of ‘0.’ If not, then its VM GC value is set to ‘−1’, indicating that the VM is marked for suspension, termination or deletion.

Otherwise, a determination is then made whether the utilization of the target VM meets the VM utilization parameters associated with a VM GC value of ‘1.’ If not, then its VM generation value is set to ‘0.’ Otherwise, a determination is made whether the utilization of the target VM meets the VM GC parameters associated with a VM generation value of ‘2.’ If not, then its VM GC value is set to ‘1.’ Otherwise the VM GC value associated with the target VM is set to ‘2.’ A determination is then made whether the selected VM has a VM GC value of ‘−1’. If so, a determination is made whether to suspend, terminate or delete the selected VM. If so, then the selected VM suspended, terminated or deleted. The method by which the selected VM with an associated VM GC value of ‘−1’ is suspended, terminated or deleted is a matter of design choice.

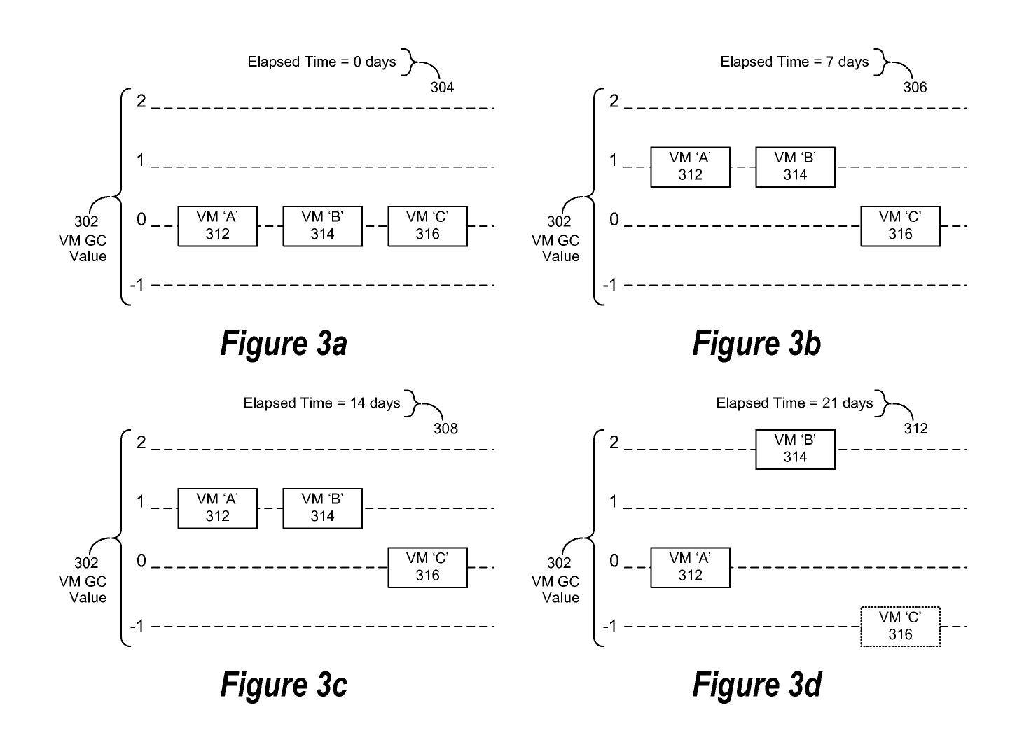

FIGS. 3A-3D are a simplified block diagram showing the automated classification of virtual machines (VMs) into VM generation classifications in accordance with an embodiment of the invention. In this embodiment, various VM utilization parameters are associated with predetermined VM generation classification (GC) values, which include:

A VM GC numeric value of ‘−1’, indicating that an associated VM is either not being used, or is underutilized, and has been marked for suspension, termination or deletion. The method of determining whether a target VM is not being used or is underutilized is a matter of design choice.

A VM GC numeric value of ‘0’, indicating that an associated VM may be newly initiated or does not met the VM utilization parameters associated with a higher or lower VM GC numeric value. In this embodiment, a target VM has to have been in operation for more than seven days, and processed a minimum of 500 requests, before it can be reclassified with a VM GC numeric value of ‘1’, as follows.

A VM GC numeric value of ‘1’, indicating that an associated VM has been in operation for more than seven days and has processed more than 500 requests during that time. In this embodiment, a target VM has to have been in operation for more than 14 days, and processed a predetermined minimum number of requests during a predetermined preceding time interval (e.g., at least 500 in the last seven days) before it can be reclassified with a VM GC numeric value of ‘2’, as follows.

A VM GC numeric value of ‘2’, indicating that an associated VM has been in operation for at least 14 days and has processed a predetermined minimum number of requests during a predetermined preceding time interval (e.g., at least 500 in the last seven days), or is designated as a permanent or prioritized VM to maintain its VM GC numeric value of ‘2’. Otherwise, the target VM is reclassified with a VM GC numeric value of ‘1’.

Referring now to FIG. 3A, VMs ‘A’ 312, ‘B’ 314, and ‘C’ 316 are newly initiated, indicated by an elapsed time 304 of 0 days, and are assigned an initial VM generation classification (GC) value 302 of ‘0’. The method by which VMs ‘A’ 312, ‘B’ 314, and ‘C’ 316 are initiated and assigned an initial VM GC value 302 is a matter of design choice. As shown in FIG. 3B, VMs ‘A’ 312 and ‘B’ 314 have now been assigned a VM GC numeric value 302 of ‘1’ as a result of the performance of various VM GC operations described in greater detail herein. In those operations, VMs ‘A’ 312 and ‘B’ 314 were found to have been in operation for an elapsed time 306 of at least 7 days and to have processed at least 500 requests. However, VM ‘C’ 316, while being in operation for at least 7 days, failed to process at least 500 requests. As a result the VM GC numeric value 302 associated with VM ‘C’ 316 continues to be ‘0’.

FIG. 3C shows that VMs ‘A’ 312 and ‘B’ 314 continue to be assigned a VM GC numeric value 302 of ‘1’, indicating that they have both processed at least 500 requests in the previous 7 days, but have not yet exceeded the minimum elapsed time 308 of 14 days. Likewise, VM ‘C’ continues to have an associated VM GC numeric value 302 of ‘0’. Then, as shown in FIG. 3D, VM ‘A’ 312 has been assigned a VM GC 302 value of ‘0’ as it has failed to process at least 500 requests in the previous 7 days, despite having been in operation for an elapsed time 312 in excess of 14 days. However, VM ‘B’ 312 has been assigned a VM GC numeric value of ‘2’ as it has not only processed at least 500 requests in the previous 7 days, but has been in operation for an elapsed time 312 in excess of 14 days. Likewise, VM ‘C’ 316 has been assigned a VM GC numeric value of ‘−1’, indicating that it is underutilized or not being used and has been marked for suspension, termination or deletion.

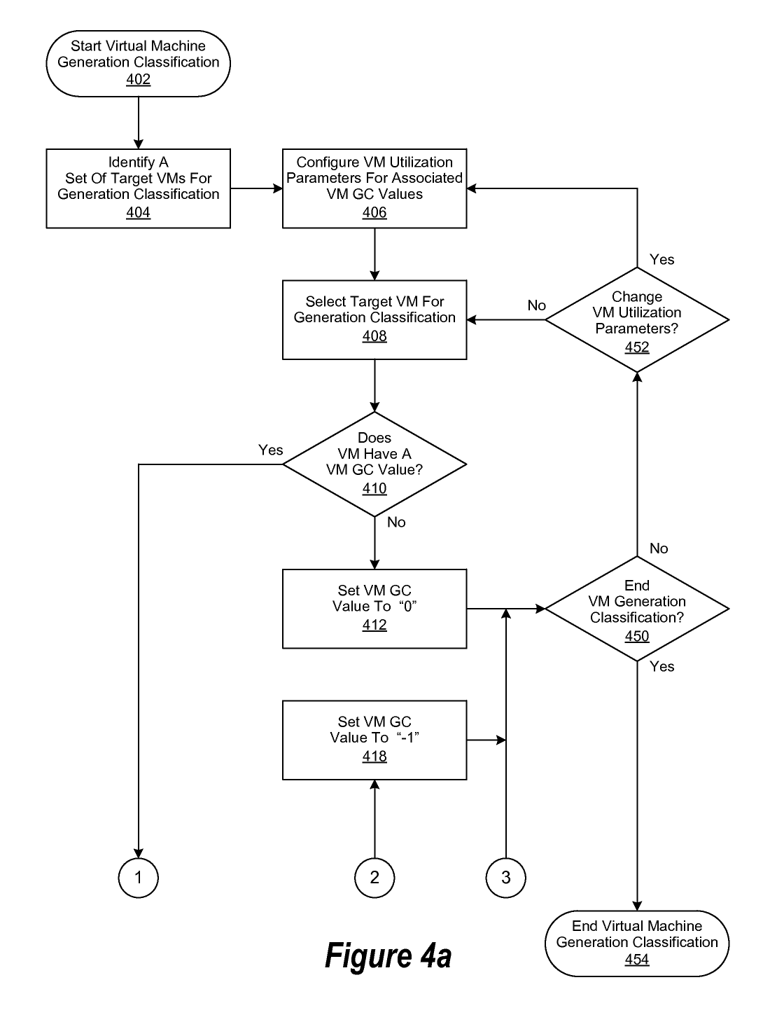

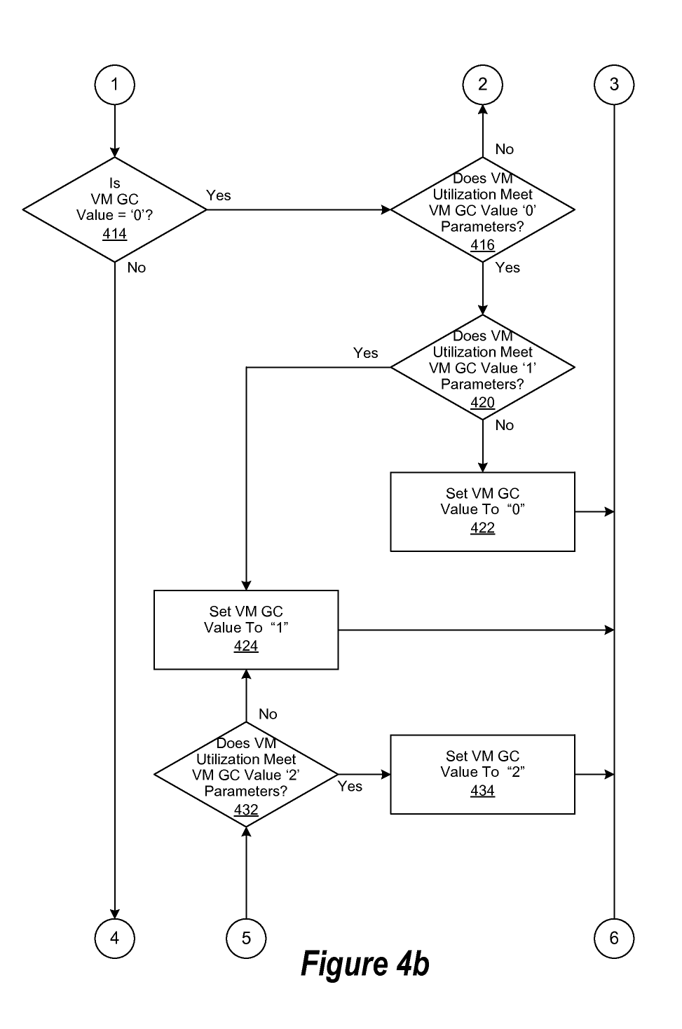

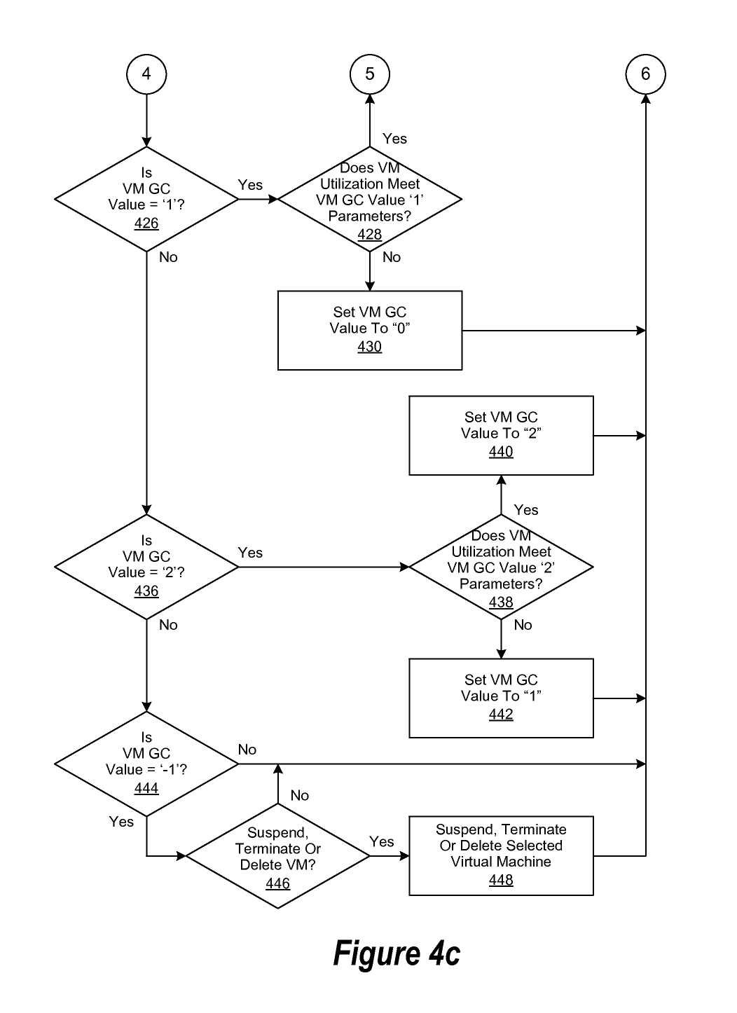

FIGS. 4A-4C are a generalized flowchart of the performance of operations implemented in accordance with an embodiment of the invention to automate the classification of virtual machines (VMs) into VM generation classifications. In this embodiment, VM generation classification (GC) operations are begun in step 402, followed by the identification of a set of target VMs in step 404 for the performance of various VM GC operations described in greater detail herein. The method of identifying the set of target VMs for the performance of VM GC operations is a matter of design choice. Once the predetermined set of target VMs has been identified in step 404, predetermined VM utilization parameters, as described in greater detail herein, are configured for their associated VM GC values in step 406.

A target VM is then selected in step 408 for the performance of VM GC operations, followed by a determination being made in step 410 whether the selected VM currently has an associated VM GC value. If it does not, then the selected VM's associated VM GC value is set to ‘0’ in step 412. A determination is then made in step 450 whether to end VM GC operations. If so, then VM GC operations are ended in step 454. Otherwise, a determination is made in step 452 whether to change the VM utilization parameters currently in use. If so, then the process is continued, proceeding with step 406. Otherwise, the process is continued, proceeding with step 408.

However, if it is determined in step 410 that the selected VM currently has an associated VM GC value, then a determination is made in step 414 whether its VM GC value is equal to ‘0’. If so, then a determination is made in step 416 whether the utilization of the selected VM meets the utilization parameters associated with a VM GC value of ‘0’. If not, the VM GC value of the selected VM is set to ‘-1’ in step 418, indicating that the VM is marked for suspension, termination or deletion, and the process is continued, proceeding with step 450.

However, if it is determined in step 416 that the utilization of the selected VM meets the utilization parameters associated with a VM GC value of ‘0’, then a determination is made in step 420 whether the utilization of the selected VM meets the utilization parameters associated with a VM GC value of ‘0’. If not, then the VM GC value of the selected VM is set to ‘0’ in step 422 and the process is continued, proceeding with step 450. Otherwise, the VM GC value of the selected VM is set to ‘1’ in step 424 and the process is continued, proceeding with step 450.

However, if it is determined in step 414 that the VM GC value associated with the selected VM is not equal to ‘0’, then a determination is made in step 426 whether its associated VM GC value is equal to ‘1’. If so, then a determination is made in step 428 whether the utilization of the selected VM meets the VM utilization parameters associated with a VM GC value of ‘1’. If not, then the VM GC value of the selected VM is set to ‘0’ in step 430 and the process is continued, proceeding with step 450.

Otherwise, a determination is made ins step 432 whether the utilization of the selected VM meets the utilization parameters associated with a VM GC value of ‘2’. If not, then the VM GC value of the selected VM is set to ‘1’ in step 424 and the process is continued, proceeding with step 450. Otherwise, the VM GC value of the selected VM is set to ‘2’ in step 434 and the process is continued, proceeding with step 450.

However, if it was determined in step 426 that the VM GC value associated with the selected VM was not equal to ‘1’, then a determination is made in step 436 whether its associated VM GC value is equal to ‘2’. If so, then a determination is made in step 438 whether the utilization of the selected VM meets the VM utilization parameters associated with a VM GC value of ‘2.’ If so, then the VM GC value of the selected VM is set to ‘2’ in step 440 and the process is continued, proceeding with step 450. Otherwise, the VM GC value of the selected VM is set to ‘1’ in step 442 and the process is continued, proceeding with step 450.

However, if it was determined in step 436 that the VM GC value associated with the selected VM was not equal to ‘2’, then a determination is made in step 444 whether the VM GC value associated with the selected VM is equal to ‘−1’. If not, then the process is continued, proceeding with step 450. Otherwise, a determination is made in step 446 whether to suspend, terminate or delete the selected VM. If not, the process is continued, proceeding with step 450. Otherwise, the selected VM is suspended, terminated or deleted in step 448 and the process is continued, proceeding with step 450.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for automating the classification of virtual machines (VMs) into VM generation classifications, comprising:
processing data associated with the utilization of a target VM to generate VM utilization data;
processing the VM utilization data to identify a corresponding VM generation classification (GC) value; and
associating the corresponding VM GC value with the target VM.

2. The method of claim 1, wherein:
the VM GC value is associated with a set of VM utilization parameters.

3. The method of claim 2, wherein a first VM GC value indicates that the target VM comprises at least one member of the set of:
is not currently in use;
is currently underutilized;
is marked for suspension;
is marked for termination; and
is marked for deletion.

4. The method of claim 2, wherein a second VM GC value indicates that the target VM comprises at least one member of the set of:
is newly initiated;
has been in operation for at least a predetermined minimum period of time;
exceeds a predetermined minimum level of VM resource utilization; and
has an associated high mortality rate.

5. The method of claim 2, wherein a third VM GC value indicates that the target VM comprises at least one member of the set of:
has been in operation for a period of time that is greater than a predetermined minimum period of time and less than a predetermined maximum period of time; and
has a level of VM resource utilization that is greater than a predetermined minimum level of VM resource utilization and less than a predetermined maximum level of VM resource utilization.

6. The method of claim 2, wherein a fourth VM GC value indicates that the target VM comprises at least one member of the set of:
has been in operation exceeding a predetermined maximum period of time;
exceeds a predetermined maximum level of VM resource utilization;
is designated a permanent VM; and
is designated as a prioritized VM.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for automating the classification of virtual machines (VMs) into VM generation classifications and comprising instructions executable by the processor and configured for:
processing data associated with the utilization of a target VM to generate VM utilization data;
processing the VM utilization data to identify a corresponding VM classification (GC) value; and
associating the corresponding VM GC value with the target VM.

8. The system of claim 7, wherein:
the VM GC value is associated with a set of VM utilization parameters.

9. The system of claim 8, wherein a first VM GC value indicates that the target VM comprises at least one member of the set of:
is not currently in use;
is currently underutilized;
is marked for suspension;
is marked for termination; and
is marked for deletion.

10. The system of claim 8, wherein a second VM GC value indicates that the target VM comprises at least one member of the set of:
is newly initiated;
has been in operation for at least a predetermined minimum period of time;
exceeds a predetermined minimum level of VM resource utilization; and
has an associated high mortality rate.

11. The system of claim 8, wherein a third VM GC value indicates that the target VM comprises at least one member of the set of:
has been in operation for a period of time that is greater than a predetermined minimum period of time and less than a predetermined maximum period of time; and
has a level of VM resource utilization that is greater than a predetermined minimum level of VM resource utilization and less than a predetermined maximum level of VM resource utilization.

12. The system of claim 8, wherein a fourth VM GC value indicates that the target VM comprises at least one member of the set of:
has been in operation exceeding a predetermined maximum period of time;
exceeds a predetermined maximum level of VM resource utilization;
is designated a permanent VM; and
is designated as a prioritized VM.

13. A non-transitory, computer-readable storage medium embodying computer program code, the computer program code comprising computer executable instructions configured for:
processing data associated with the utilization of a target VM to generate VM utilization data;
processing the VM utilization data to identify a corresponding VM generation classification (GC) value; and
associating the corresponding VM GC value with the target VM.

14. The non-transitory, computer-readable storage medium of claim 13, wherein:
the VM GC value is associated with a set of VM utilization parameters.

15. The non-transitory, computer-readable storage medium of claim 14, wherein a first VM GC value indicates that the target VM comprises at least one member of the set of:
is not currently in use;
is currently underutilized;
is marked for suspension;
is marked for termination;
is marked for deletion.

16. The non-transitory, computer-readable storage medium of claim 14, wherein a second VM GC value indicates that the target VM comprises at least one member of the set of:
is newly initiated;
has been in operation for at least a predetermined minimum period of time;
exceeds a predetermined minimum level of VM resource utilization; and
has an associated high mortality rate.

17. The non-transitory, computer-readable storage medium of claim 14, wherein a third VM GC value indicates that the target VM comprises at least one member of the set of:
has been in operation for a period of time that is greater than a predetermined minimum period of time and less than a predetermined maximum period of time; and
has a level of VM resource utilization that is greater than a predetermined minimum level of VM resource utilization and less than a predetermined maximum level of VM resource utilization.

18. The non-transitory, computer-readable storage medium of claim 14, wherein a forth the VM GC value indicates that the target VM comprises at least one member of the set of:
has been in operation exceeding a predetermined maximum period of time;
exceeds a predetermined maximum level of VM resource utilization;
is designated a permanent VM; and
is designated as a prioritized VM.
